(19) United States
(12) Patent Application Publication
(10) Pub. No.: US 2006/0157301 A1
(43) Pub. Date: Jul. 20, 2006

(54) MOBILE STEP-LADDER FOR CARS/BUSES AND SPORTS UTILITY VEHICLES

(76) Inventor: Anders Embretsen, 824 50 Hudiksvall (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 10/905,670

(22) Filed: Jan. 15, 2005

(51) Int. Cl. E06C 5/00

(52) U.S. Cl. 182/150

(57) ABSTRACT

This invention is for a foldable (FIG. 9) mobile step ladder (1) for vehicles. Two parallel protruding bars (3) enclose an upper part of the tire (2) and is fixated by urging the bars (3) toward the tire and the weight of the user is prevent from sliding away from the tire. When the support leg (5) is expanded there is a foot step (7) to be stepped on to make it easier for a person to get up to the platform (6). During use the cooperation between the bars (3) and the transversely extending bar (4) and the weight of the user on the platform (6) the bars (3) are fixated by the pressure against the tire so that it does not glide off. The support leg (5) stands on the ground without gliding on the ground since the step ladder (1) is fixated on the tire of the vehicle (2).

### THE TECHNICAL FIELD OF THE INVENTION

This invention refers to a step ladder adapted to make it possible during use to reach the roof of the vehicle for loading and attaching luggage in roof boxes or roof racks. There are ladders/step-ladders of many types that can be used for this. They are permanently attached to the back end of the car and they are foldable to be used in the home. They are either free-standing or bulky for the purpose and slide easily on surfaces that are wet or slippery in the winter time. The permanently attached devices are adapted to be mounted on bigger vehicles such as vans and bigger buses.

### BACKGROUND OF THE INVENTION

Many have minibuses and vehicles for off-road terrain driving. These vehicles are often so high that it is difficult to load on the roof and in roof boxes although there are steps mounted below side-panels and there is a step on the rear bumper on certain models. When these foot steps are used it is easy to kick the painted surfaces of the car causing damage. One must also hold oneself with a hand to prevent from falling backwardly and the user has only one hand free for lifting and packing and even then unnecessary damage to the vehicle may occur.

### THE PURPOSES AND CHARACTERISTICS OF THE INVENTION

The present invention is aimed at solving the above mentioned problem. A basic purpose of the invention is therefore to create a constructive step ladder for the vehicle that does not have to be permanently attached and it foldable instead and stable to stand on during use.

By using the tire and the ground as support to stand on and hang to the user stands steadily and securely under the condition that the vehicle is turned off and the parking brake tightened and that it stands on solid ground.

According to the invention, one fundamental purpose is at least achieved with the characteristics of the ingress of the patent claims. Preferably embodiments of the invention are further defined in the dependent claims.

### BRIEF DESCRIPTION OF THE APPENDED DRAWINGS

FIG. 1 is a partial perspective view of an automobile/SUV with the step ladder of the present invention mounted on the tire.

FIG. 2 is a partial perspective view of the step ladder according to the invention.

FIG. 3 is an end view of the expanded step ladder.

FIG. 4 is a front view of the expanded step ladder.

FIG. 5 is a top view of the expanded step ladder.

FIG. 6 is a bottom view of the expanded step ladder.

FIG. 7 is an end view of the step ladder mounted on a tire.

FIG. 8 is a side view of the foregoing view.

FIG. 9 is a side view in the folded position.

FIG. 10 is a side view of the foregoing view in the expanded position.

FIG. 11 shows alternative embodiments of the invention.

### DETAILED DESCRIPTION OF THE PREFERRED EMBODIMENT OF THE INVENTION

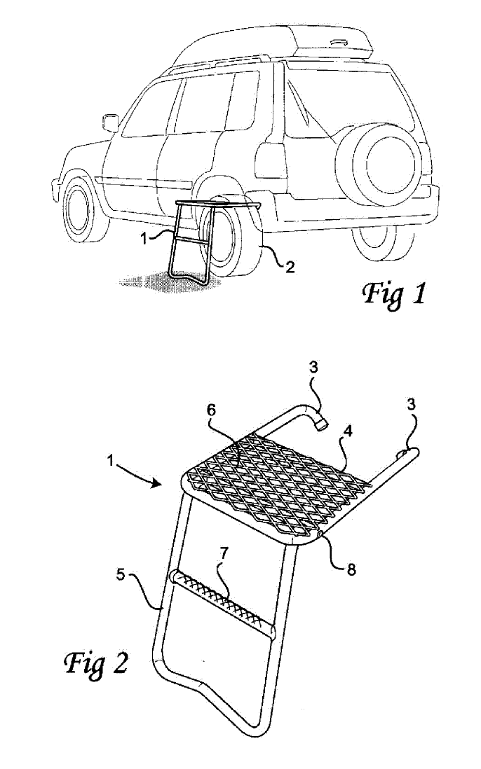

FIG. 1 shows a vehicle that has a step ladder 1 according to the invention above the left rear tire 2.

FIG. 2 is a free standing partial perspective view of the step ladder that shows the parallel protruding bars 3 that has downwardly angled ends that enclose the inner part of the tire. A front of the platform 6 has a bar 4 extending across as a stop member so that the step ladder 1 does not glide towards the car (FIG. 1), the bar 3, can be bent into one single piece around and below the platform and then be welded to the bar 4 across the bars 3 so that these function as a frame for the plat form 6. The metal is welded into the frame that the bars 3 and 4 form. At a back edge below the platform 6, the support legs 5 that have a foot step 7 extending across with slip protection between two downwardly attached bar that forms the support legs 5 of the support ladder 1.

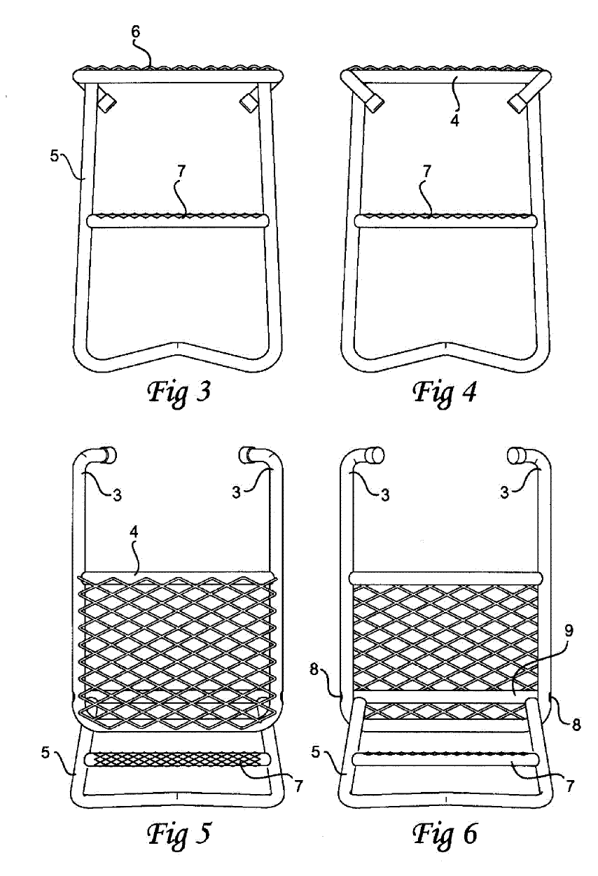

FIG. 3 is an end view of the invention where the support legs and the intermediate step 7 extending across. The step 7 has a slip protection at an upper end thereof that may be a grooved bar or in the alternative a piece of slip protection that is attached on the bar 7 that in turn is ground or clamped at the ends to bear against the bars so that the welding joints obtain good attachment surfaces.

FIG. 4 shows a front view of the step ladder where the parallel and downwardly bent and enclosing bar ends 3 are shown. The bar 4 is at the front edge of the platform 6 that functions as a stop member so that the step ladder does not glide against the vehicle. This bar should be ground at the ends for effective bearing against the bar and so that the weld joint obtain good attachment surfaces.

FIG. 5 is a top view of the platform 6 including the slip protection and the opening for surrounding the tire and the forward edge of the platform the bar 4 extending there-across is a stop member so that the ladder does not slide against the vehicle.

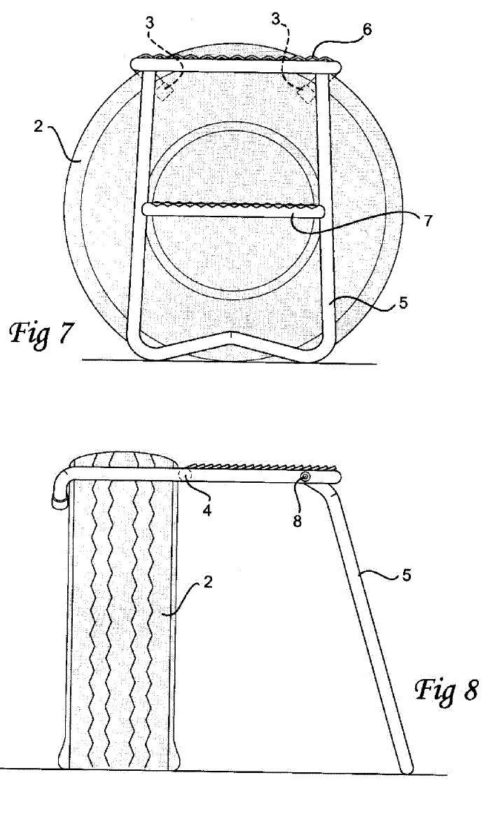

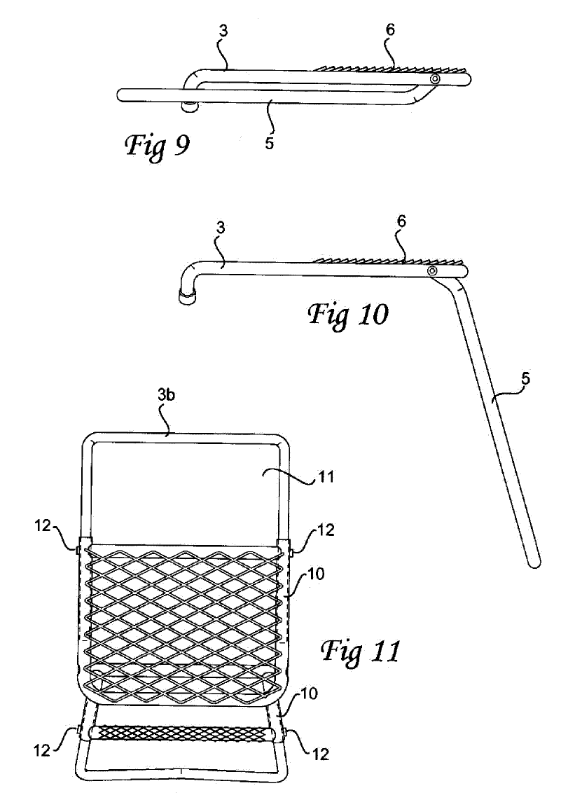

FIG. 6 is a bottom view of the step ladder where the attachment points of the support legs are shown. An axle 8 that extends across the upper bar 9 and the support legs 5, is welded so that the support legs 5 and rotatably to be folded up against the platform 6 and its forwardly protruding bar 3 so that the step ladder may be folded as shown in FIG. 9. The support leg 5 is also made in one piece by bending and grinding the ends for good fit so that the weld is stable against the bar 9 that is rotatable at the axle 8. It is attached to the bar 3 by using lock members at each end of the axle 8. In the alternative, the axle 8 can be welded to the inside of the bar 3.

FIG. 7 shows an end view of the step ladder where it encloses a tire 2 via its downwardly bent bar 3 (dashed).

FIG. 8 shows the foregoing view in a side view where the stop member 4 (dashed) is seen against the outside of the tire 2 and the bar 3 is shown as enclosing the tire 2, inside the attachment of the support leg 5 under the platform 6. The position of the locking member 8 of the axle is shown in a side view of the bent end of the upper part of the support leg 5 terminated against the bar 3 below the back edge of the platform 6. In this way the support leg has an angle in an expanded position so that the step ladder 1 is urged against the tire 2 when under a load.

FIG. 9 shows a folded side view.

FIG. 10 shows an upright expanded side view.

FIG. 11 shows a top view of alternative embodiments of the invention wherein the front edges of the bars 3 are attached to one another and form a rectangular loop that enclose the tire 2. The bar has a telescopically movable so that the height and width of the tire 2 on different vehicles can be adjusted to. They are locked in place by a locking device.

What is claimed is:

1. A mobile step ladder (1) for mounting over a tire on vehicles (2) characterized therein that two parallel protruding bar profiles, with downwardly bent ends (3), extending over a wheel (2) of the vehicle so that the bars bear against the tire during use of the step ladder, a weight of the user in combination with a support edge at a back edge providing a pressure against the tire to fixate the step ladder so that the step ladder does not glide off the tire during use, a bar (4) extending across the bars (3) on an opposite side of the tires below a front edge of a slid protecting platform (6) as a stop member so that the step ladder does not slide against the vehicle, a downward support leg being disposed at a back edge of a lower part of the platform, the support leg having a slid protected step (7) disposed thereon for making it easier for a user to get onto the slid protected platform (6) of the step ladder (1), the support leg (5) being attached at an upper end to a bar (9) that has an axle extending therethrough that holds the bar (9) in place so that the support leg (5) is movable to be folded as shown in FIG. 9.

2. The step ladder according to claim 1 characterized therein that two parallel protruding bars (3) that has downwardly bent ends to grip the tire (2), the bar (4) extends across the protruding bars (3), on an opposite of the tire the platform (6) has a front edge that functions as a stop member to prevent the step ladder (1) from gliding toward the vehicle.

3. The step ladder according to claim 1 characterized therein that a continuous bar (3b) to form an oval loop (11) that cooperates with the transverse welded bar (4) that is hung around the tire (2) to fixate the step ladder (1) in place during use.

4. The step ladder according to any of the previous claims characterized therein that the bars are telescopically adjustable (10) to be adjusted both to height and width according to different vehicles and tire dimensions and a locking member (12) is locked so that the platform (6) is horizontal.

5. The step ladder according to any of the previous claims characterized therein that it is foldable (FIG. 9) since the support leg (5) is rotatably attached (8) below the platform (6) so that it is foldable when not in use (see FIG. 9) and take up minimal space in for example a trunk of the vehicle.

6. The step ladder according to any of the previous claims characterized therein that the two parallel protruding bars (3) has forward downwardly bent ends that are connected to one another and a transverse bar enclose the tire (2) and has a foot step (7) that extends across the parallel support legs (5) at a back edge of the platform (6) to make it easier to step on the platform (6).
